(19) United States
(12) Patent Application Publication
(10) Pub. No.: US 2011/0195720 A1
(43) Pub. Date: Aug. 11, 2011

(54) METHOD FOR MANAGING IDENTIFICATION INFORMATION OF HETEROGENEOUS CELLS

(76) Inventors: Seung Hee Han, Gyeonggi-do (KR); Yeong Hyeon Kwon, Gyeonggi-do (KR); Jin Sam Kwak, Gyeonggi-do (KR); Dong Cheol Kim, Gyeonggi-do (KR); Sung Ho Moon, Gyeonggi-do (KR); Min Seok Noh, Gyeonggi-do (KR); Hyun Woo Lee, Gyeonggi-do (KR)

(21) Appl. No.: 13/056,590

(22) PCT Filed: Aug. 21, 2009
(86) PCT No.: PCT/KR2009/004669

§ 371 Date: Jan. 28, 2011

Related U.S. Application Data
(60) Provisional application No. 61/090,903, filed on Aug. 22, 2008.
(60) Provisional application No. 61/092,416, filed on Aug. 28, 2008.

(30) Foreign Application Priority Data
Nov. 27, 2008 (KR) 10-2008-0118822

(51) Int. Cl. H04W 72/00; H04B 7/14

(52) U.S. Cl. 455/450; 455/7

(57) ABSTRACT

Described is a method for managing the identification information of a relay station/femtocell/picocell. It is suggested that the identification information of the relay station/femtocell/picocell inherits either a first or second partial cell ID of the identification information allocated to a region that covers the relay station/femtocell/picocell if the identification information of the relay station/femtocell/picocell comprises the first and second partial cell IDs. At this time, the inherited ID may be a sector ID. The first and second partial cell IDs may or may not have a hierarchical structure.

### BACKGROUND OF THE INVENTION

1. Field of the Invention

The present invention relates to identification (ID) information of a relay station in a wireless communication system, and more particularly, to a method for efficiently allocating ID information to a relay station and efficiently acquiring, by a terminal, the ID information of the relay station.

2. Discussion of the Related Art

Relay stations are predicted to be widely used in next generation wireless communication systems. A brief description of the concept of relay stations is as follows.

The concept of relay stations considered in IEEE 802.16j will be described hereinbelow for the sake of simplicity of description. However, the relay stations which will be described may also be applied to relay stations considered in the 3^{rd} Generation Partnership Project (3GPP) IMT-Advanced (IMT-A) (LTE-A) as substantially the same concept.

In Institute of Electrical and Electronics Engineers (IEEE) 802.16 in 2006, a standardization project of a new topic called a multihop relay has been underway since IEEE 802.16-2004, which is standard specification targeted at fixed subscriber terminals, and IEEE 802.16e-2005, which is standard specification to provide mobility to subscriber terminals, are published. This project handled by task group j in IEEE 802.16 has started real discussion about usage models, terminology, and technical requirements at the second meeting on July 2006 after the first official meeting on May 2006. Hereinafter, IEEE 802.16 task group j will be abbreviated to “802.16j”.

In the Project Authorization Request (PAR) of 802.16j, the following two standardization objectives to be processed are specified:

1. Coverage extension

2. Throughput Enhancement

FIG. 1 is a concept diagram of a multihop relay system.

In FIG. 1, reference numeral 701 denotes a base station, reference numerals 702a to 702d denote relay stations, and reference numerals 703a to 703d denote terminals. As illustrated in FIG. 1, signals may be transmitted even to an area outside an area of the base station 701 through the relay stations 702a and 702b. Moreover, for the terminal 703d within the area of the base station 701, a high-quality path having a high level adaptive modulation and coding scheme may be set through the relay station 702d and as a result system capacity may be increased with the same wireless resources.

The standard specification to be made by this project appears to be limited to addition of a partial function for controlling relay stations themselves, and existing base stations and relay stations, under the principle that mobile terminals achieved based on the existing 802.16-2004 and 802.16e-2005 specifications must be capable of communicating with relay stations without adding any functions. Accordingly, specification for relay stations is expected to be a core issue of the future standardization.

A relay station may be considered a kind of subscriber terminal for performing operation of a physical layer and a medium access control layer. Although the relay station is controlled mainly by a base station, it is supposed to have some control functions when necessary. As utilization models which are being discussed, not only fixed relay stations but also mobile relay stations and relay stations which may be installed in automobiles or subways, for providing temporary services to specific areas are considered.

Typical technical issues to be discussed in future may be summarized as follows.

1. Procedure for a base station to identify relay stations within its range and acquire and maintain information on topology with the relay stations.

2. Definition of a physical transport frame structure between a mobile terminal and a relay station which have backward compatibility with the existing IEEE 802.16/16e systems.

3. Signaling procedure for providing mobility between relay stations or between a relay station and a base station.

4. Network entry procedure of a relay station to a base station and network entry procedure of a mobile terminal through a relay station.

In addition to these issues, many other technical issues may exist. However, compatibility with existing systems is expected to the biggest obstacle to solving these issues. This is because, as mentioned previously, the principle that all mobile terminals achieved based on the existing 802.16-2004 and 802.16e-2005 standards must be capable of communicating with base stations through relay stations without adding any functions may be restrictions representing that almost all functions defined in the existing two standards must be possible through the relay stations and simultaneously may function as a factor which can increase the complexity of relay stations. Hence, how to solve such problems appears to greatly affect a standardization progress speed and marketability.

Meanwhile, a femtocell will now be described as a similar concept to the above-described relay station.

“Femto” denotes a very small factor of 10⁻¹⁵. In this meaning, a femtocell refers to an ultra-small/low-power indoor base station for use in households and offices. Although femtocell and picocell are often used interchangeably, femtocell is used to refer to a cell having a more advanced function than picocell. The femtocell is a small-sized cellular base station connected to a broadband router and functions to transmit 3^{rd} Generation (3G) voice and data as well as existing 2^{nd} Generation (2G) voice and data to a backbone network of a mobile communication provider through a Digital Subscriber Line (DSL) link.

The advantages of the femtocell will now be described hereinbelow.

Recently, a survey report was published and drew attention showing that the femtocell could help to expand 3G and increase indoor coverage. The report forecast that the number of femtocell users worldwide will reach 102 million by 2011 and the number of installed Access Points (APs) will reach 32 million. According to chief analyst of ABI Research, Stuart Carlaw, “From a technological standpoint, their better in-building coverage for technologies such as WCDMA, HSDPA and EVDO is an incredibly important aspect of service delivery. From a strategic and financial standpoint, the routing of traffic through the IP network significantly enhances network quality and capacity, and reduces the OPEX that carriers expend on backhaul.”

Femtocells can expand cell coverage and increase the quality of voice service. Mobile communication service providers are expecting that subscribers may be familiar with 3G by providing data service via femtocells. The femtocells may also be called Femto Base Stations (FBSs) or Femto Base

Transceiver Stations (BTSs).

In summary, femtocells are analyzed as having the following advantages.

1. Cell coverage improvement

2. Infrastructure cost decrease

3. New service offering

4. Fixed Mobile Convergence (FMC) acceleration.

Meanwhile, a picocell will now be described as another similar concept to the above-described relay station.

A picocell is a wireless communication system typically covering a small area such as offices, shopping malls, train stations, and more recently in-aircrafts. The concept of picocell may be similar to a WiFi AP.

In a cellular wireless communication system such as GSM, a picocell base station is typically a low-cost, small-sized (generally A4 paper size, and 2-3 cm thick) unit for connecting to a Base Station Controller (BSC). Multiple picocell ‘heads’ connect to each BSC. The BSC performs radio resource management and handover functions, and aggregates data to be passed to the Mobile Switching Centre (MSC) and/or GPRS Support Node (GSN).

Connectivity between the picocell heads and the BSC typically consists of in-building wiring. Although originally deployed systems (1990s) used PDH links such as E1/T1 links to connect between the picocell heads and the BSC, more recent systems use Ethernet cables.

More recent work has focused on developing a head unit containing not only a picocell, but also many of the functions of the BSC and some of the MSC. This form of picocell is sometimes called an AP base station or the above-described femtocell. In this case, the above-mentioned header unit may contain all the capabilities required for direct connection to the Internet, without the need for the BSC/MSC infrastructure.

In cellular networks, picocells are used to increase in-building coverage where eternal signals are not well reached generally, or to improve network capabilities in an area having very high traffic load such as in train stations.

Meanwhile, FIG. 2 is a diagram explaining cell names typically used according to cell radius.

Although there is no definition for accurate numeric reference of a cell radius in respective cell names, cell names may be typically classified according to cell coverage as follows.
Megacell: 100-500 Km in radius
Macrocell: up to 35 Km in radius (about 5-30 km)
Microcell: up to 1 Km in radius
Picocell: up to 50 m or 200 m

In the following description, for the sake of convenience of description, the above-described relay station, microcell, femtocell, and picocell will be collectively referred to as a “relay station” as the concept of a small AP for coverage improvement, which is distinguished from a megacell, macrocell, etc. That is, in the following description, the concept of a relay station includes the concept of a femtocell, a picocell, and the like.

Research needs to be performed into a method of efficiently allocating ID information to the above-described relay station and efficiently acquiring, by a terminal, the ID information of the relay station.

### SUMMARY OF THE INVENTION

In an aspect of the present invention for solving the above-described problems, a method for allocating ID information to a relay station in a multiple cell environment communication system includes allocating, as a sector ID of the relay station, a sector ID in a combination of a cell ID and a sector ID allocated to a specific cell or sector which provides a service to an area in which the relay station is located, and allocating a cell ID to the relay station so that the relay station is distinguished from other relay stations in the specific cell or sector.

The cell ID allocated to the relay station may be overlapped with a cell ID of a relay station located within another cell or sector.

In another aspect of the present invention, a method for allocating ID information to a relay station in a multiple cell environment communication system includes, if a first partial cell ID and a second partial cell ID are used as respective service area ID information by combinations and the second partial cell ID is set to have values of different ranges according to a value of the first partial cell ID, inheriting, as an ID of the relay station, any one of first partial cell ID and second partial cell ID allocated to a specific cell or sector which provides services to an area in which the relay station is located.

The first partial cell ID may a cell ID and the second partial cell ID may be a cell ID, but they are not limited thereto. The relay station may inherit a sector ID allocated to the specific cell or sector as a sector ID of the relay station.

In another aspect of the present invention, a method for acquiring ID information of a relay station in a multiple cell environment communication system includes receiving a synchronization channel in which an ID of the relay station is included in the form of a combination of a sector ID and a cell ID, and sequentially detecting the sector ID and the cell ID, wherein a sector ID of the relay station is the same as a sector ID included in a combination of a cell ID and a sector ID allocated to a specific cell or sector in which the relay station is located.

A cell ID of the relay station may be distinguished from other relay stations in a specific cell or sector in which the relay station is located. A cell ID of the relay station may be overlapped with a cell ID of a relay station located within a specific cell or sector in which the relay station is located or within another cell or sector.

In another aspect of the present invention, a method for acquiring ID information of a relay station in a multiple cell environment communication system includes receiving a synchronization channel including ID information of the relay station in the form of a combination of a first partial cell ID and a second partial cell ID, and sequentially detecting the first partial cell ID and the second partial cell ID, wherein the second partial cell ID is set to have values of different ranges according to a value of the first partial cell ID and any one of the ID information of the relay station inherits any one of a first partial cell ID and a second partial cell ID allocated to a specific cell or sector in which the relay station is located.

The first partial cell ID may be a sector ID, the second partial cell ID may be a cell ID, and the relay station may inherit a sector ID allocated to the specific cell or sector as a sector ID of the relay station.

Here, the cell ID may be called a NodeB ID or a BS ID.

In the above aspects, it is assumed that the concept of the relay station includes a femtocell and a picocell. Further, assuming deployment between heterogeneous cells, the concept of the relay station includes the concept of deployment between different cells.

Meanwhile, in the above aspects, “sector ID” is typically associated with a reuse pattern. For example, in a system in which a reuse factor is 3, reuse#0 may correspond to an alpha sector of sector ID #0, reuse#1 may correspond to a beta sector of sector ID#1, and reuse#2 may correspond to a gamma sector of sector ID#2. If the reuse factor is 6, reuse#0/#1 may correspond to an alpha sector of sector ID #0, reuse#2/#3 may correspond to a beta sector of sector ID#1, and reuse#4/#5 may correspond to a gamma sector of sector ID#2. Accordingly, inheriting the sector ID may be interpreted as inheriting a reuse pattern index of the above-described meaning.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a concept diagram of a multihop relay system;

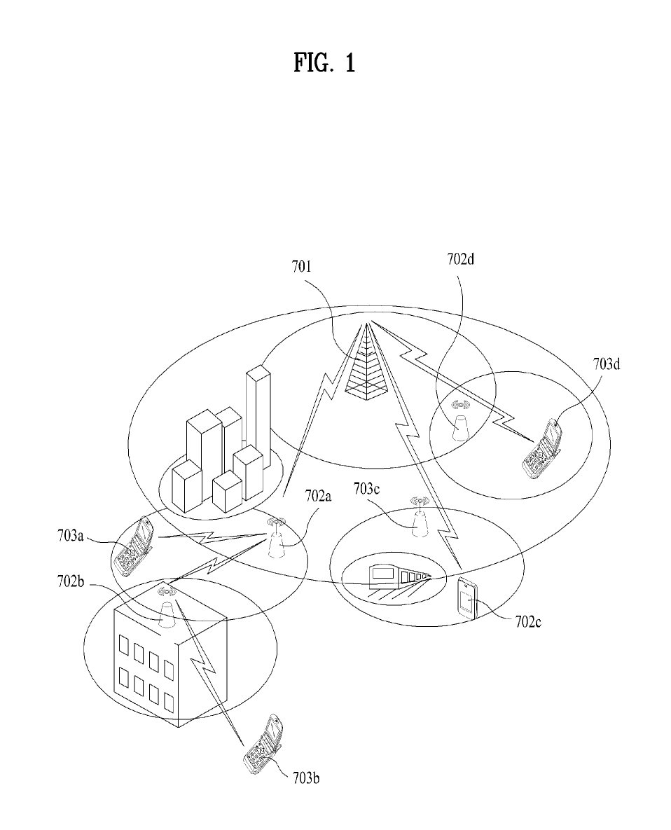

FIG. 2 is a diagram explaining cell names typically used according to cell radius;

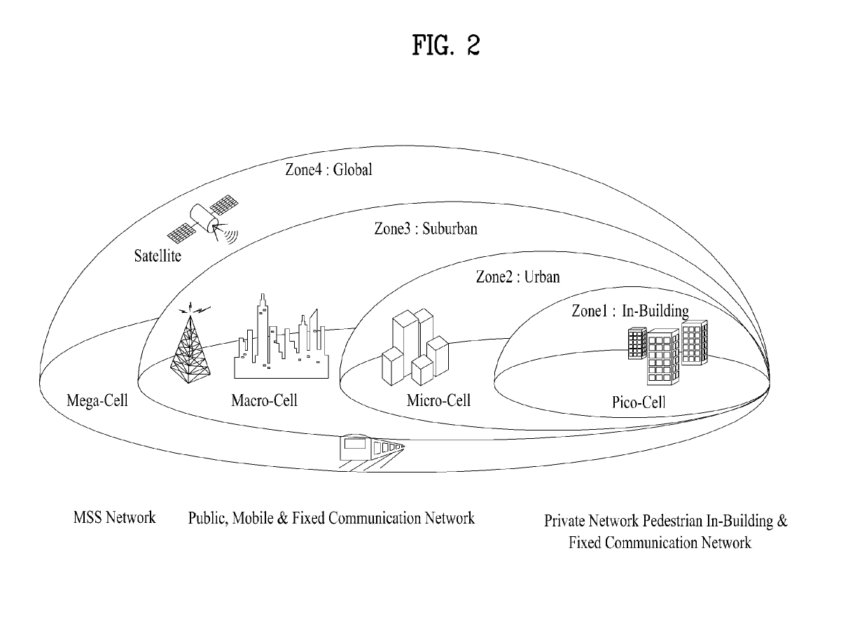

FIG. 3 is a diagram illustrating a general frame structure of IEEE 802.16m;

FIG. 4 is a diagram illustrating a location of a synchronization channel of IEEE 802.16m within a super-frame;

FIG. 5 is a diagram illustrating the relationship between a preamble of IEEE 802.16e and a synchronization channel of IEEE 802.16m in a legacy-support mode of IEEE 802.16m;

FIG. 6 is a diagram illustrating a structure in which frequency reuse is applied to a synchronization channel; and

FIG. 7 is a diagram illustrating an example of allocating cell IDs to femtocells, relay stations, etc. when multiple cells are mixed according to an exemplary embodiment of the present invention.

### DETAILED DESCRIPTION OF THE INVENTION

Reference will now be made in detail to the exemplary embodiments of the present invention with reference to the accompanying drawings. The detailed description, which will be given below with reference to the accompanying drawings, is intended to explain exemplary embodiments of the present invention, rather than to show the only embodiments that can be implemented according to the invention.

The following detailed description includes specific details in order to provide a thorough understanding of the present invention. However, it will be apparent to those skilled in the art that the present invention may be practiced without such specific details. In some instances, known structures and devices are omitted or are shown in block diagram form, focusing on important features of the structures and devices, so as not to obscure the concept of the present invention. The same reference numbers will be used throughout this specification to refer to the same or like parts.

As described above, the present invention provides a method for efficiently allocating ID information to a relay station and efficiently acquiring, by a terminal, the ID information of the relay station.

Generally, cell ID information is transmitted through a synchronization channel and it is desirable for ID information of a relay station to be transmitted through the synchronization channel. The synchronization channel, which will be used throughout the present specification, is referred to by different names in different systems. For example, the synchronization channel is called a Synchronization Signal (SS) in 3GPP LTE and is called a preamble in IEEE 802.16e. Accordingly, the “synchronization channel” throughout the overall description of the present invention is assumed to refer collectively to a channel/signal, etc., through which a terminal performs time/frequency synchronization with a base station.

By referring to a structure of the above-described synchronization channel or preamble, a method will be embodied for efficiently allocating/transmitting cell ID information for a relay station and efficiently acquiring the cell ID information.

First, a structure in an IEEE 802.16m system will be described.

The following description is based on IEEE 802.16e standard, that is, Orthogonal Frequency Division Multiplexing (OFDM) parameters of IEEE 802.16e in the following Table 1.

However, a new frame structure of IEEE 802.16m is also based on the same parameters so as to have a 5 ms frame structure.

TABLE 1

| Transmission | | | |
|---|---|---|---|
| Bandwidth (MHz) | 5 | 10 | 20 |
| Over-sampling Factor | 28/25 | | |
| Sampling Frequency | 5.6 | 11.2 | 22.4 |
| (MHz) | | | |
| FFT Size | 512 | 1024 | 2048 |
| Sub-carrier Spacing | 10.94 | | |
| (kHz) | | | |
| OFDM Symbol Time, Tu | 91.4 | | |
| (us) | | | |
| | | OFDM | |
| Cyclic Prefix | | Symbols | Idle Time |
| (CP) | Ts (us) | per Frame | (us) |
| Tg = ¼ Tu | 91.4 + 22.85 = 114.25 | 43 | 87.25 |
| Tg = ⅛ Tu | 91.4 + 11.42 = 102.82 | 48 | 64.64 |
| Tg = 1/16 Tu | 91.4 + 5.71 = 97.11 | 51 | 47.39 |
| Tg = 1/32 Tu | 91.4 + 2.86 = 94.26 | 53 | 4.22 |

An IEEE 802.16m (hereinafter, abbreviated to “16 m”) frame is different from an IEEE 802.16e (hereinafter, abbreviated to “16e”) frame in that, in a 16m frame structure, there is a super-frame structure including a plurality of frames and a small-sized sub-frame structure is included in one frame.

The efficiency of transmission can be increased through a super-frame structure because control information which does not need to be frequently transmitted is transmitted in units of super-frames. Moreover, data allocation and scheduling are performed most frequently in units of sub-frames, thereby reducing delay characteristics of data transmission considering retransmission mechanism. A super-frame considered for the 16m frame structure includes 4 frames and 8 sub-frames constitute one frame. However, this structure is merely exemplary and super-frames and sub-frames of other sizes may be applied.

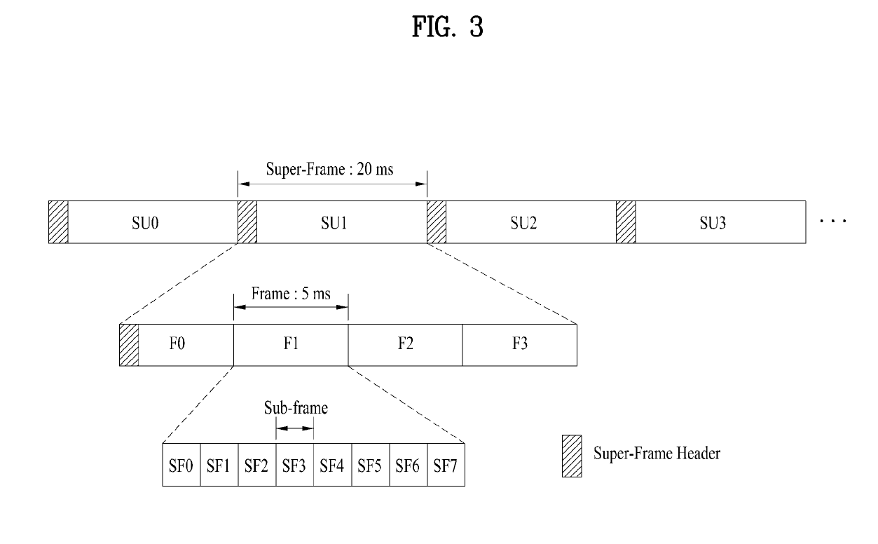

FIG. 3 illustrates a general frame structure of IEEE 802.16m.

As described earlier, FIG. 3 illustrates an example in which 4 frames constitute one super-frame and 8 sub-frames constitute one frame. Each super-frame may include control information called a Super-Frame Header (SFH).

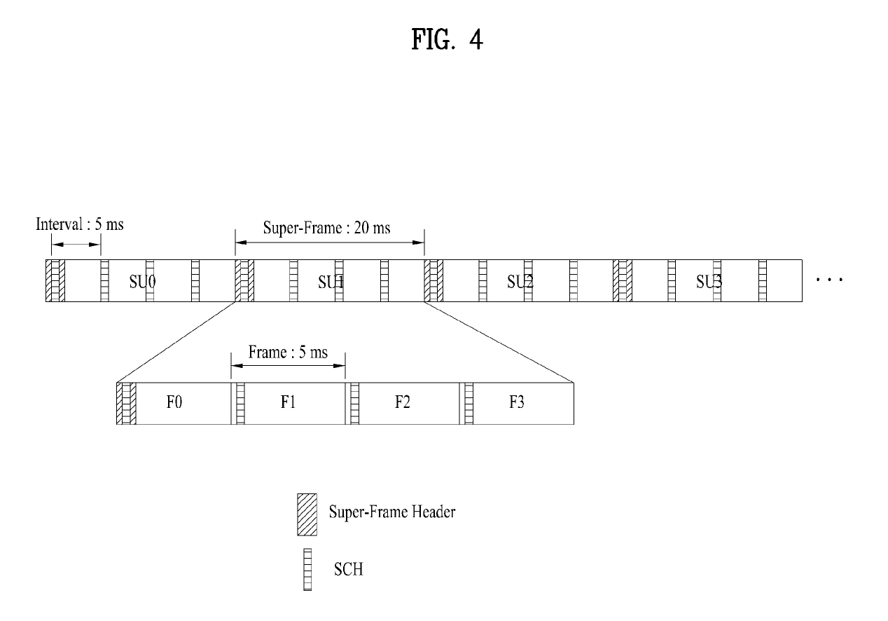

FIG. 4 is a diagram illustrating a location of a synchronization channel of IEEE 802.16m within a super-frame.

Each Synchronization Channel (hereinafter, “SCH”) may consist of one OFDM symbol. Alternatively, the SCH may be comprised of a hierarchical SCH structure in which an additional SCH symbol for initial synchronization/cell information acquisition or synchronization/cell information acquisition during handover is present every frame, in addition to the SCH symbol. However, FIG. 4 illustrates the simplest form of a non-hierarchical SCH structure and shows an example of a transmission period of 5 ms which is the most frequent.

An SCH structure of the above-described IEEE 802.16 series may be broadly classified into two structures according to a method for acquiring initial timing/frequency synchronization.

The first method is to acquire initial timing/frequency synchronization using cross-correlation properties. In this case, an SCH should be transmitted to all subcarriers in a frequency axis. If an SCH is transmitted only to even subcarriers or only to odd subcarriers, or in the case of generalizing the above example, that is, if an SCH signal is transmitted only to n-th (n>=2) subcarriers, an ambiguous peak occurs while cross-correlation is performed, which may be problematic in the formation of initial timing/frequency synchronization.

The second method is to acquire initial timing/frequency synchronization using auto-correlation properties. In this case, an SCH should be transmitted such that a repetitive pattern of a signal appears in a time axis. The simplest way to form a repetitive pattern in a time axis is to carry an SCH signal only onto every n-th (n>=2) subcarrier in a frequency axis.

The following Table 2 shows advantages and disadvantages of the two types of channel structures.

TABLE 2

| | Pros | Cons |
|---|---|---|
| Cross-correlation | It can obtain a sharpened peak | The complexity increases |
| based algorithm | in timing acquisition under very small | significantly. |
| | frequency offset environment. It means | In order to achieve the |
| | the coarse timing step can be skipped | fundamental goal, i.e, cell search, of |
| | in the synchronization procedure. | the synchronization channel, it |
| | | requires, at least, one additional |
| | | channel either in |
| | | time/frequency/code/space domain to |
| | | carry cell ID information. This is |
| | | because it is not feasible to adapt |
| | | multiple correlators for hundreds of |
| | | hypothesis tests during the timing |
| | | detection from practical |
| | | implementation perspective. |
| | | Under a large frequency |
| | | offset environment, the benefit of |
| | | sharpened peak would disappear due |
| | | to partial correlation which could |
| | | result in stubby peak. |
| Auto-correlation | The complexity is very small. | Additional fine timing is |
| based algorithm | It is possible for the | required after cell ID detection. |
| | synchronization channel to consist of | |
| | only a single OFDM symbol. In other | |
| | words, it does not require additional | |
| | resources or channels. | |
| | It can works well regardless of | |
| | frequency offset effect due to | |
| | differential operation. | |

Consequently, it may be appreciated that an auto-correlation based SCH structure is preferred because it may reduce the amount of calculation by a terminal during reception and may not be influenced by frequency offset.

A preamble of IEEE 802.16e has an SCH structure for supporting an auto-correlation based synchronization algorithm due to the above-described reason and has a structure in which a transmission signal is carried on every 3^{rd} subcarrier in a frequency axis so that 3 repetitive patterns appear in a time axis. Even in an SCH of IEEE 802.16m, repetitive patterns should be formed in a time axis.

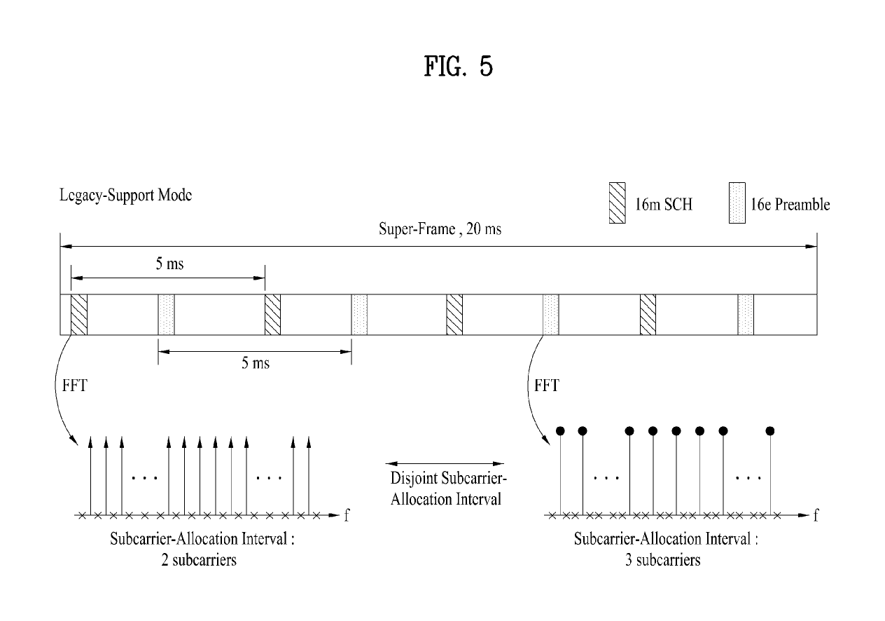

FIG. 5 is a diagram illustrating the relationship between a preamble of IEEE 802.16e and an SCH of IEEE 802.16m in a legacy-support mode of IEEE 802.16m.

As described previously, it is desirable that the 16m SCH be set to be able to detect an SCH by auto-correlation through repetitive patterns in a time axis.

However, in a legacy-support mode (that is, a mode in which SCHs of 16e and 16m are mixedly transmitted by TDM) as shown in FIG. 5, the SCH of 16m may be transmitted to have a repetition factor corresponding to a number that is a relative prime with 3 in order to avoid confusion between the SCH of 16m and a preamble signal of 16e.

Meanwhile, a terminal may undergo interference from a neighboring cell during reception of an SCH and such interference may bring about performance degradation during cell ID acquisition. Furthermore, in a network in which a frequency reuse factor of 3 is applied using an SCH, accuracy may be decreased during measurement of Channel Quality (CQ) received per cell. Accordingly, frequency reuse may be applied to an SCH as a method for substantially solving the above problems.

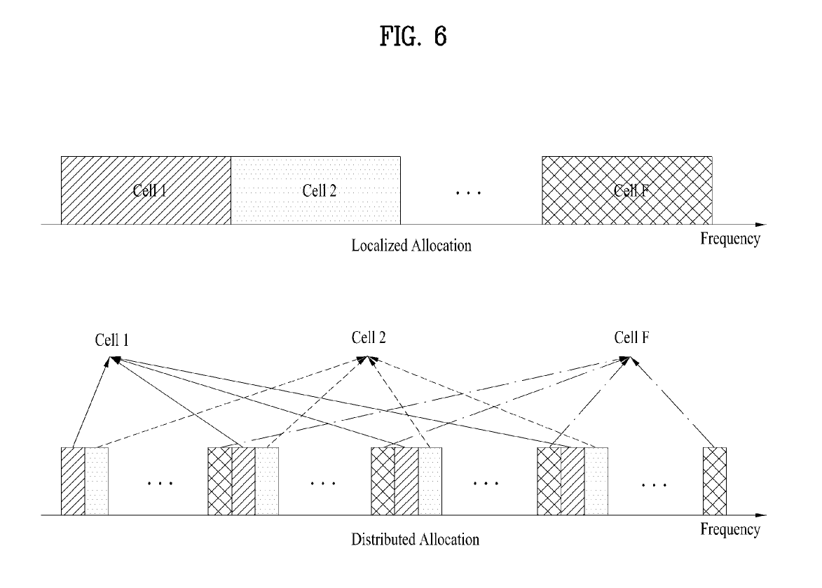

FIG. 6 is a diagram illustrating a structure in which frequency reuse is applied to an SCH.

In FIG. 6, a frequency reuse factor F is assumed. F cells are deployed using determined parts of a frequency axis so as not to overlap each other and there are no restrictions as to a detailed deployment method. For example, there may be a localized allocation method, as shown in the upper part of FIG. 6, in which frequency resources for a specific cell are localized at a specific part. On the contrary, there may be a distributed allocation method, as shown in the lower part of FIG. 6, in which frequency resources for a specific cell are distributed over the whole frequency band.

A method will be described hereinbelow for transmitting cell ID information of a relay station and efficiently identifying the cell ID information, based on the above-described SCH structure according to the present invention.

In one exemplary embodiment of the present invention, the use of an SCH of a hierarchical structure is proposed to reduce complexity during detection of cell ID information.

Let's assume that there are a total of 510 physical cell IDs for example. In this case, typically, 510 different codes should be defined and a terminal should detect a cell to which it belongs by performing correlation with respect to the 510 codes.

In this exemplary embodiment, it is assumed that the entire cell IDs are divided into partial cell IDs such as cell ID1s and cell ID2s. That is, the entire cell IDs has a structure of a total of cell IDs=cell ID1*cell ID2. For example, 510 physical cell IDs may be divided into 3 cell ID1s and 170 cell ID2s (510=3*170). Cell ID1 may be transmitted through one time/frequency/code/space resource and cell ID2 may be transmitted through another one time/frequency/code/space resource. According to the above-described example, cell ID1 may define 3 codes and cell ID2 may define 170 codes.

When such cell ID information is transmitted, a receiving stage may detect a final cell ID through three correlation operations to detect cell ID1 and 170 correlation operations to detect cell ID2. Namely, the final cell ID may be detected through a total of 173 correlation operations.

In this case, cell ID1 may be called a sector ID and cell ID2 may be called a cell ID. If the number of cell ID1s is 3, the cell ID1s may be for a 3-sector system. That is, a cell ID1 may be sector—specifically allocated and a cell ID2 may be cell-specifically allocated in IEEE 802.16 series.

Alternatively, a cell ID2 may be allocated to a nodeB ID and a cell ID1 may be allocated to each sector within the NodeB ID in 3GPP series.

However, when a hierarchical cell ID structure is merely used according to the above-described embodiment, the following ambiguity problem may occur. In the following description, a combination of a cell ID and a sector ID, or a combination of a first partial cell ID and a second partial cell ID will be referred to as (sector ID, cell ID) or (first partial cell ID, second partial cell ID).

For example, if there are two cells and if a cell A has a combination of (0, 1) and a cell B has a combination of (2, 3), a terminal may detect a wrong combination such as (0, 3) or (2, 1) by wrongly combining a first partial cell component and a second partial cell component in both cells.

Further, if the above-described method is applied to a case where multiple cells, such as macro-, micro-, pico-, femto-cells, and relay cells, are mixed, the ambiguity problem may become more serious.

Therefore, a method for transmitting cell ID information of a relay station and a method for acquiring, by a terminal, the cell ID information of the relay station according to an exemplary embodiment of the present invention which will be described hereinafter are based on performing cell planning so as to solve the above-described ambiguity problem.

More specifically, it is assumed that in the exemplary embodiment of the present invention a combination of a sector ID and a cell ID is set to have a hierarchical structure of a final cell ID. For example, a structure of cell ID_final=cell ID*sector ID is the same as the above-described method. A 3-sector structure may be set as cellID_final=510, cell ID=170, and sector ID=3. A 6-sector structure may be set as cellID_final=510, cell ID=85, and sector ID=6. The 6-sector structure may be defined by doubling the 3-sector structure.

Under the above assumption, it is proposed in this embodiment that, when multiple cells are mixed, a small coverage cell (e.g. a relay station) inherits a sector ID of a large coverage cell and has an ID of another cell to distinguish between respective cells. For example, it is proposed that a sector ID in cellID_final of femto/pico/relay station uses a sector ID that is the same as a sector ID of a macrocell to which they belong.

More specifically, if a relay station (femto/pico cell) is present within a macrocell having sector ID=2 and cell ID=100, the relay station may have sector ID=2 and cell ID=99. This may be set as described above when an operator designs a system and may be set through a Self Organization Network (SON).

Moreover, relay stations (femto/pico cells) within different large cells may inherit sector IDs of the cells to which the relay stations belong and may have the same cell ID if the cells have different sectors/cells. For example, an ID of a femtocell A belonging to a macrocell having (0, 50) may be (0, 27) and an ID of a femtocell B belonging to a macro cell having (1, 50) may be (1, 27). In other words, it is assumed that, when an ID is allocated to a relay station (femto-/pico-cell), a sector ID of a cell to which it belongs is restricted.

Even when a cell to which the relay station belongs does not introduce a sectorization concept (that is, if a sector ID is only one, for example, sector ID=0), the above-described method may be applied.

For the sake of convenience, (sector ID, cell ID) is used to designate cellID_final. It is assumed that a femtocell is present in a dense area within a macrocell having (0, 100). If the femtocell does not inherit a sector ID of the macrocell to which the femtocell belongs and has cellID_final of (1,50), a terminal may incur wrong alarm of (0, 50) or (1,100).

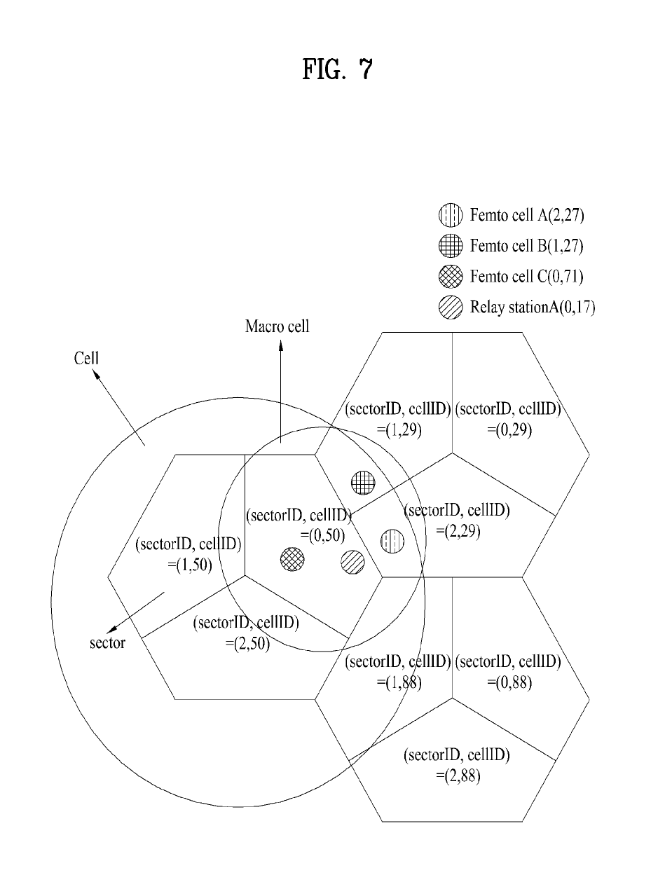

FIG. 7 is a diagram illustrating an example of allocating cell IDs to femtocells, relay stations, etc. when multiple cells are mixed according to an exemplary embodiment of the present invention.

In the example of FIG. 7, a femtocell A is located in an area covered by a sector of which (sector ID, cell ID) is (2, 29) and has an ID of (2, 27) by inheriting sector ID=2. A femtocell B is located in an area covered by a sector of (1, 29) and inherits sector ID=1. A femtocell C and a relay station A inherit sector IDs of sectors covering them by the above-described method and have cell IDs to be distinguished from other femtocells or relay stations in the same cell/sector.

While the above embodiment has described a case where a cell ID is in the form of (sector ID, cell ID), it is not restricted thereto. If a cell is in the form of (first partial cell ID, second partial cell ID) and if a terminal detects a second partial cell ID of a corresponding cell among second partial cell IDs related to the first partial cell ID after detecting the first partial cell ID, the above embodiment may be generalized in a way that a relay station inherits any one partial cell ID of a cell/sector which covers the relay station. In this case, the first partial cell ID and the second partial cell ID may have or may not have a hierarchical structure.

In another embodiment of the present invention unlike the above embodiment, a range of specific cell IDs may be reserved to identity femtocell/picocell/relay station based on physical cell IDs. For example, if it is desired to reserve 51(=3*17) physical cell IDs from 510(=3*170) physical cell IDs, 17 cell IDs may be reserved.

According to the above-described embodiments, ID information can be efficiently allocated to a relay station and a terminal can efficiently acquire the ID information of the relay station.

Especially, when a cell ID has a dual structure, according to the above-described embodiments, cell detection speed is improved and ambiguity is solved, thereby improving cell detection performance.

The embodiments described above can be widely used as a method for allocating cell ID information and acquiring, by a terminal, the ID information in various wireless communication systems to which relay stations/femtocells/picocells are applied.

It will be apparent to those skilled in the art that various modifications and variations can be made in the present invention without departing from the spirit or scope of the inventions. Thus, the present invention covers the modifications and variations of this invention provided they come within the scope of the appended claims and their equivalents.

What is claimed is:

1. A method for allocating ID information to a relay station in a multiple cell environment communication system, comprising:
allocating, as a sector ID of the relay station, a sector ID in a combination of a cell ID and a sector ID allocated to a specific cell or sector which provides a service to an area in which the relay station is located; and
allocating a cell ID to the relay station so that the relay station is distinguished from other relay stations in the specific cell or sector.

2. The method of claim 1, wherein the cell ID allocated to the relay station can be overlapped with a cell ID of a relay station located within another cell or sector.

3. The method of claim 1, wherein the relay station includes a femtocell and a picocell.

4. A method for allocating ID information to a relay station in a multiple cell environment communication system, comprising:
if a first partial cell ID and a second partial cell ID are used as respective service area ID information by combinations and the second partial cell ID is set to have values of different ranges according to a value of the first partial cell ID, inheriting, as an ID of the relay station, any one of first partial cell ID and second partial cell ID allocated to a specific cell or sector which provides services to an area in which the relay station is located.

5. The method of claim 4, wherein the first partial cell ID is a sector ID, the second partial cell ID is a cell ID, and the relay station inherits a sector ID allocated to the specific cell or sector as a sector ID of the relay station.

6. A method for acquiring ID information of a relay station in a multiple cell environment communication system, comprising:
receiving a synchronization channel in which an ID of the relay station is included in the form of a combination of a sector ID and a cell ID; and
sequentially detecting the sector ID and the cell ID,
wherein a sector ID of the relay station is the same as a sector ID included in a combination of a cell ID and a sector ID allocated to a specific cell or sector in which the relay station is located.

7. The method of claim 6, wherein a cell ID of the relay station is distinguished from other relay stations in a specific cell or sector in which the relay station is located.

8. The method of claim 6, wherein a cell ID of the relay station can be overlapped with a cell ID of a relay station located within a specific cell or sector in which the relay station is located or within another cell or sector.

9. The method of claim 6, wherein the relay station includes a femtocell and a picocell.

10. A method for acquiring ID information of a relay station in a multiple cell environment communication system, comprising:
receiving a synchronization channel including ID information of the relay station in the form of a combination of a first partial cell ID and a second partial cell ID; and
sequentially detecting the first partial cell ID and the second partial cell ID,
wherein the second partial cell ID is set to have values of different ranges according to a value of the first partial cell ID and any one of the ID information of the relay station inherits any one of a first partial cell ID and a second partial cell ID allocated to a specific cell or sector in which the relay station is located.

11. The method of claim 10, wherein the first partial cell ID is a sector ID, the second partial cell ID is a cell ID, and the relay station inherits a sector ID allocated to the specific cell or sector as a sector ID of the relay station.
